(19) United States
(12) Patent Application Publication
(10) Pub. No.: US 2025/0333316 A1
(43) Pub. Date: Oct. 30, 2025

(54) SYSTEM AND METHOD FOR PRODUCING AMMONIA

(71) Applicant: Siemens Energy Global GmbH & Co. KG, München (DE)

(72) Inventors: Suhel Ahmad, Duisburg (DE); Peter Adam, Nürnberg (DE); Lukas Biyikli, Ratingen (DE)

(21) Appl. No.: 18/864,573

(22) PCT Filed: May 26, 2023
(86) PCT No.: PCT/EP2023/064164

§ 371 Date: Nov. 11, 2024

(30) Foreign Application Priority Data
May 31, 2022 (DE) 10 2022 205 453.9

(51) Int. Cl. C01C 1/04; B01J 19/00

(52) U.S. Cl. CPC C01C 1/0452; B01J 19/0013; B01J 2219/00103

(57) ABSTRACT

The invention relates to a system and a method for generating ammonia, wherein, in an ammonia reactor, ammonia (NH3) is generated from a synthesis gas, wherein the synthesis gas contains hydrogen (H2) and nitrogen (N2), wherein a nitrogren supply flow and a first heat exchanger are used, which are designed in such a way that the hot ammonia (NH3) flowing out of the ammonia reactor heats the nitrogen used as synthesis gas in the nitrogen supply flow.

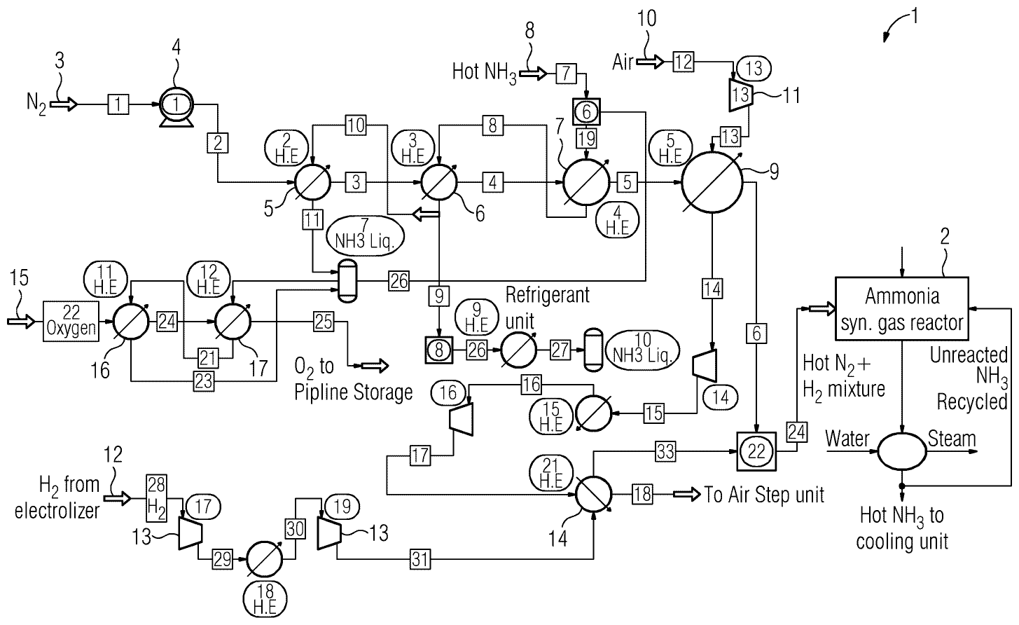

### BACKGROUND

The invention relates to a plant and a process for producing ammonia, wherein in an ammonia reactor ammonia (NH₃) is produced from a synthesis gas, wherein the synthesis gas comprises hydrogen (H₂) and nitrogen (N₂).

The production of ammonia goes back to a known process which generally requires a great deal of energy. According to initial estimates about 1% of the energy generated worldwide is currently used for production of ammonia.

Ammonia produced from renewable energies is known as green ammonia. Green ammonia is considered to be a fast-growing energy carrier for hydrogen. It is moreover used in many industrial processes, especially in fertilizers. It is estimated that about 50% of the green hydrogen produced in the coming years will be directly converted into liquid ammonia for long-distance transportation of hydrogen, since liquefaction of pure hydrogen is very energy-intensive.

The most energy—and compression-intensive processes other than the hydrogen production by electrolysis and the nitrogen production by air separation plants is the synthesis gas compression, which compresses the nitrogen-hydrogen mixture to the pressure of 150-200 bar required for the synthesis process, and the cold box, which provides the refrigeration energy for the liquefaction and cooling of the ammonia to about −33° C. at atmospheric pressure.

A preheating unit for heating the synthesis gas to the reaction temperature is generally required.

Presently, the nitrogen and hydrogen required for ammonia production are typically compressed to the required synthesis pressure in a synthesis gas compressor. The inlet pressure for this compressor is generally determined by the hydrogen pressure which in the case of green ammonia applications where the electrolysis is operated on site is limited to the maximum starting pressure of an electrolysis system (max. 30-40 bar).

The shaft power for the compressor is provided by a steam turbine while the required steam is generated by the heat liberated during the ammonia synthesis. The preheating of the synthesis gas must be effected either through a fuel-or electricity-powered heater or through waste heat recovery from the ammonia process, thus reducing the amount of producible steam for the steam turbine.

Liquefaction is effected via a refrigerant circuit.

### SUMMARY

It is an object of the present invention to provide an improved plant and an improved process for producing ammonia, especially in respect of the use of the energy required for production of ammonia.

The invention proposes an innovative concept for an environmentally friendly ammonia plant through integration of an electrolyzer with renewable energy and an air separation plant utilizing refrigeration to reduce the total energy demand and improve the overall economy.

The above-described properties, features and advantages of the present invention as well as the manner in which they are achieved are more clearly and particularly elucidated in connection with the following description of the exemplary embodiments which are more particularly elucidated in connection with the figures.

Identical components or components with identical function are labelled with identical reference numerals.

### BRIEF DESCRIPTION OF THE DRAWINGS

Exemplary embodiments of the invention are hereinbelow described with reference to the drawings. These are not intended to be scale drawings of the exemplary embodiments but rather the drawing, where useful for elucidation, is in a schematic and/or slightly distorted form. Having regard to additions to the teachings immediately apparent in the drawing, reference is made to the relevant prior art.

The FIGURE shows a schematic representation of a plant for producing ammonia.

### DETAILED DESCRIPTION

The FIGURE shows a plant 1 for producing ammonia. A substantial component of the plant 1 is the ammonia reactor (2) which is configured according to the prior art. A detailed description of the ammonia reactor 2 is therefore dispensed with here.

In the ammonia reactor 2 a synthesis gas is supplied. The synthesis gas comprises hydrogen (H₂) and nitrogen (N₂). The hydrogen (H₂) and nitrogen (N₂) react in the ammonia reactor according to the chemical reaction

$${N}_{2} + 3 {H}_{2} \to 2 {NH}_{3} + 92 kJ / mol$$

This chemical reaction is a strongly exothermic reaction, i.e. the ammonia NH₃ formed in the ammonia reactor has a relatively high temperature, wherein according to the invention this high temperature is used for preheating the nitrogen N₂.

The plant I comprises a nitrogen feed 3 for supplying nitrogen as synthesis gas. The nitrogen is supplied to a first pump 4 and passes from there to a heat exchanger 5. The nitrogen heated in the heat exchanger 5 passes into a further heat exchanger 6 and undergoes further heating there. The nitrogen heated in the heat exchanger 6 passes into a further heat exchanger 7 and undergoes further heating there.

The plant 1 comprises a feed 8 for hot ammonia produced in the ammonia reactor. The hot ammonia successively passes through the heat exchangers 7, 6 and 5 to undergo cooling, and the temperature of the nitrogen simultaneously increases.

Before the heated nitrogen flows into the ammonia reactor the nitrogen is heated via a further heat exchanger 9.

The plant 1 comprises an air feed 10 for supplying air. The air is supplied to a first compressor 11 and passes from there to the heat exchanger 9. The compressor 11 is part of an air separation plant and is therefore also referred to as the Main Air Compressor (MAC). The air flows through the heat exchanger 9 to undergo cooling, and the temperature of the nitrogen simultaneously increases.

The nitrogen heated in the heat exchanger 9 passes to the ammonia reactor 2.

The plant 1 comprises a hydrogen feed 12 for supplying hydrogen. The hydrogen is supplied to a compressor unit 13 and passes from there to the heat exchanger 14. The heat exchanger 9 is supplied with air from the air feed 10. The air undergoes cooling and the temperature of the nitrogen simultaneously increases.

The plant 1 comprises an oxygen feed 15 for supplying oxygen. The oxygen flows through two heat exchangers 16 and 17 and undergoes heating there. The ammonia cooled in the heat exchangers 2, 3 and 4 undergoes further cooling in the heat exchangers 16 and 17, with the result that the ammonia is finally in the liquid phase and is thus readily transportable.

The present invention thus proposes a concept for improving energy efficiency through three primary considerations:
1. pumping out liquid N₂ from the air separation plant instead of compression in the gas phase to reactor pressure.
2. utilizing the refrigeration energy from the air separation plant for partial liquefaction and cooling of NH₃.
3. Preheating N₂ and H₂ using waste heat formed during the air compression of the air separation plant.

The essential features of the plant 1 will now be elucidated again hereinbelow, wherein the reference numerals used in the following refer to the reference numerals relating to the components. These reference numerals are therefore indicated either with rectangular boxes or round boxes.

Liquid N2 (stream 1) is generated in the air separation plant at atmospheric pressure and at about −195° C., pumped to a reactor pressure (150-210 bar) with a pump (pump 1) and subsequently, together with ammonia (stream 7) and hot air (stream 13) produced in the main air compressor of the air separation plant (compressor 13), heated to up to 250° C. (heat exchanger 2), evaporated (heat exchanger 3) and superheated (heat exchangers 4 and 5).

Hydrogen is either generated on site by electrolysis or supplied via a pipe conduit at a pressure between 1 and 60 bar (stream 28) and subsequently compressed to the reactor pressure (150-210 bar) in an H₂ compressor (compressors 17 and 19 with heat exchanger 18 as an intermediate cooler), which may either be a turbo compressor or a piston compressor, and subsequently preheated to 168° C. using hot air (stream 17) generated in the booster air compressor of the air separation plant (compressors 14 and 16 with heat exchanger 15 as an intermediate cooler).

The actual ammonia reaction process remains unchanged, i.e. the exothermic heat of reaction is utilized for producing steam, which may be used for electricity generation and/or for driving compression plants, and the unconverted synthesis gas is recycled.

The NH₃ exiting the water boiler at 40-50° C. (stream 7) is cooled by cold nitrogen and oxygen from the ASU and partially liquefied (11%) in the heat exchangers 12, 11, 4, 3 and 2. The remaining 89% (stream 9) are supplied to a refrigerant unit (heat exchanger 9) and liquefied there. The three liquid NH₃ streams (stream 11, stream 23 and stream 27) may then be collected for subsequent transport in a storage container.

1. A plant for producing ammonia, comprising:
an ammonia reactor configured for producing ammonia (NH₃) from a synthesis gas, wherein the synthesis gas comprises hydrogen (H₂) and nitrogen (N₂); and
a nitrogen feed and a first heat exchanger configured such that the ammonia (NH₃) exiting the ammonia reactor heats the nitrogen used as synthesis gas in the nitrogen feed.

2. The plant as claimed in claim 1, further comprising a further heat exchanger configured such that an air heated in an air separation plant effects further heating of the nitrogen heated from the first heat exchanger.

3. The plant as claimed in claim 1, further comprising an electrolyzer configured for producing hydrogen (H₂) used as synthesis gas, wherein the hydrogen (H₂) is heated with a compressor unit.

4. The plant as claimed in claim 3, further comprising a heat exchanger configured such that the air heated in the plant effects further heating of the hydrogen heated from the heat exchanger.

5. The plant as claimed in claim 1, further comprising a heat exchanger configured such that an oxygen produced in an air separation plant cools the ammonia produced in the ammonia reactor.

6. The plant as claimed in claim 1, wherein the ammonia from the ammonia reactor is cooled via the heat exchangers such that the ammonia comprises a liquid phase.

7. A process for producing ammonia, wherein in an ammonia reactor ammonia (NH₃) is produced from a synthesis gas, wherein the synthesis gas comprises hydrogen (H₂) and nitrogen (N₂), wherein a nitrogen feed and a first heat exchanger, configured such that the ammonia (NH₃) exiting the ammonia reactor heats the nitrogen used as synthesis gas in the nitrogen feed, are employed.

8. The process as claimed in claim 7, wherein a further heat exchanger, configured such that an air heated in an air separation plant effects further heating of the nitrogen heated from the first heat exchanger, is employed.

9. The process as claimed in claim 7, wherein an electrolyzer configured for producing hydrogen (H₂) used as synthesis gas is employed, wherein the hydrogen (H₂) is heated with a compressor unit.

10. The process as claimed in claim 9, wherein a heat exchanger, configured such that air heated in an air separation plant effects further heating of the hydrogen heated from the heat exchanger, is employed.

11. The process as claimed in claim 7, wherein a heat exchanger, configured such that an oxygen produced in an air separation plant cools the ammonia produced in the ammonia reactor, is employed.

12. The process as claimed in claim 7, wherein the ammonia from the ammonia reactor is cooled by the heat exchangers such that the ammonia comprises a liquid phase.
